(19) United States
(12) Patent Application Publication
(10) Pub. No.: US 2013/0260139 A1
(43) Pub. Date: Oct. 3, 2013

(54) HEAT-RAY SHIELDING MATERIAL

(71) Applicant: FUJIFILM Corporation, Tokyo (JP)

(72) Inventors: Koh KAMADA, Ashigarakami-gun (JP); Naoharu KIYOTO, Ashigarakami-gun (JP)

(73) Assignee: FUJIFILM Corporation, Tokyo (JP)

(21) Appl. No.: 13/898,871

(22) Filed: May 21, 2013

Related U.S. Application Data
(63) Continuation of application No. PCT/JP2011/076619, filed on Nov. 18, 2011.

(30) Foreign Application Priority Data
Nov. 22, 2010 (JP) 2010-260493

(51) Int. Cl. C03C 17/00

(52) U.S. Cl. CPC C03C 17/007
USPC 428/328; 252/587

(57) ABSTRACT

A heat ray-shielding material including a heat ray-shielding layer which includes flat silver particles and metal oxide particles is provided. Preferable aspects include: an aspect of the metal oxide particles including tin-doped indium oxide particles; an aspect of the heat ray-shielding layer including flat silver particles and metal oxide particles mixed and dispersed in a binder; and an aspect of the heat ray-shielding layer including a flat silver particle-containing layer including the flat silver particles and a metal oxide particle-containing layer including the metal oxide particles laminated therein.

### CROSS-REFERENCE TO RELATED APPLICATION

This is a continuation application of PCT/JP2011/076619, filed on Nov. 18, 2011.

### BACKGROUND OF THE INVENTION

1. Field of the Invention

The present invention relates to a heat ray-shielding material having superior visible-light transmittance, radio-wave transmittance and lightfastness, capable of shielding near-infrared light in wide band, and having a high shielding ratio of near-infrared light.

2. Description of the Related Art

In recent years, as one of the energy conservation measures to reduce carbon dioxide, heat ray-shielding materials for windows of cars and buildings have been developed. For example, a metal Ag film is commonly used as a heat ray-reflecting material because of its high reflectivity. However, it reflects not only a visible light and heat rays but also radio waves, and its low visible light transmittance and radio-wave transmittance have been a problem. In order to increase the visible light transmittance, a Low-E glass which uses an Ag and ZnO multilayer film (e.g., manufactured by Asahi Glass Co., Ltd.) has been widely used for buildings. However, the Low-E glass has a metal Ag film formed on a glass surface, and there has been a problem of low radio-wave transmittance.

In order to solve the problems, for example, a glass with island-shaped Ag particles imparted with radio-wave transmittance has been proposed. A glass with granular Ag formed thereon by annealing an Ag film formed by vapor deposition has been proposed (see Japanese Patent (JP-B) No. 3454422). However, since the granular Ag is formed by annealing in this proposal, it is difficult to control a size, a shape, an area ratio and so on of the particles. Thus, there have been problems of difficulties in controlling a reflection wavelength, a band and so on of heat rays and in improving visible light transmittance.

Also, as an infrared shielding filter, filters using flat Ag particles have been proposed (see Japanese Patent Application Laid-Open (JP-A) No. 2007-108536, JP-A No. 2007-178915, JP-A No. 2007-138249, JP-A No. 2007-138250 and JP-A No. 2007-154292). However, these proposals are all intended to be used in plasma display panels, and they use particles having a small volume in order to improve an absorption capacity of a light having a wavelength in an infrared region. None of them used flat Ag particles as a material for shielding heat rays (material which reflects heat rays).

Meanwhile, tin-doped indium oxide (ITO) particles used for a transparent electrode ensures a shielding ratio of 1,200 nm or greater of 90% or greater and a visible light transmission of 90%. However, there has been a problem that it cannot shield a near-infrared light having a wavelength of 800 nm to 1,200 nm with a high thermal energy.

Also, a heat rays shielding film which includes a heat rays shielding layer including ITO particles and a heat rays shielding layer including a diimmonium-based material as an organic heat ray-shielding material and an ultraviolet-absorbing material (see JP-A No. 2008-020525) has been proposed. However, there is a problem that it has an insufficient visible light transmittance of 60%. Also, the lightfastness was insufficient with the diimmonium-based material. Even though an ultraviolet-absorbing material is included in the same layer, the film degrades due to heating of the film itself, ultraviolet rays included in the sunlight and so on, and there has been a problem of a rapidly decreasing heat ray-shielding effect.

### SUMMARY OF THE INVENTION

The present invention aims at solving the above problems in the conventional technologies and at achieving the following objection. That is, the present invention aims at providing a heat ray-shielding material having superior visible-light transmittance, radio-wave transmittance and lightfastness, capable of shielding near-infrared light in wide band, and having a high shielding ratio of near-infrared light.

Means for solving the problems are as follows. That is:

<1> A heat ray-shielding material, including a heat ray-shielding layer which includes flat silver particles and metal oxide particles.

<2> The heat ray-shielding material according to <1>, wherein the metal oxide particles are tin-doped indium oxide particles.

<3> The heat ray-shielding material according to any one of <1> to <2>,

wherein the flat silver particles include flat silver particles having a substantially hexagonal shape or a substantially disc shape by 60% by number or greater.

<4> The heat ray-shielding material according to any one of <1> to <3>,

wherein the flat silver particles have a coefficient of variation in a particle size distribution of 30% or less.

<5> The heat ray-shielding material according to any one of <1> to <4>,

wherein the flat silver particles have an average particle diameter of 40 nm to 400 nm, and the flat silver particles have an aspect ratio (average particle diameter/average particle thickness) of 5 to 100.

<6> The heat ray-shielding material according to any one of <1> to <5>,

wherein a content of the flat silver particles in the heat ray-shielding layer is 0.02 g/m² to 0.20 g/m².

<7> The heat ray-shielding material according to any one of <1> to <6>,

wherein a content of the metal oxide particles in the heat ray-shielding layer is 1.0 g/m² to 4.0 g/m².

<8> The heat ray-shielding material according to any one of <1> to <7>,

wherein the heat ray-shielding material has a visible light transmittance of 65% or greater and an average transmittance at a wavelength of 780 nm to 2,000 nm of 20% or less.

<9> The heat ray-shielding material according to any one of <1> to <8>,

wherein the heat ray-shielding layer includes the flat silver particles and the metal oxide particles mixed and dispersed in a binder.

<10> The heat ray-shielding material according to any one of <1> to <8>,

wherein the heat ray-shielding layer includes a flat silver particle-containing layer including the flat silver particles and a metal oxide particle-containing layer including the metal oxide particles laminated therein.

The present invention can solve the conventional problems, achieve the objectives and provide a heat ray-shielding material having superior visible-light transmittance, radio-wave transmittance and lightfastness, capable of shielding near-infrared light in wide band, and having a high shielding ratio of near-infrared light.

### BRIEF DESCRIPTION OF THE DRAWINGS

FIG. 1 is a schematic diagram illustrating one example of a heat ray-shielding material of the present invention.

FIG. 2 is a schematic diagram illustrating another example of a heat ray-shielding material of the present invention.

FIG. 3A is a schematic perspective diagram illustrating one example of a shape of flat particles included in a heat ray-shielding material of the present invention, illustrating the flat particles having a substantially disc shape.

FIG. 3B is a schematic perspective diagram illustrates one example of a shape of flat particles included in a heat ray-shielding material of the present invention, illustrating the flat particles having a substantially hexagonal shape.

FIG. 4A is a schematic cross-sectional diagram illustrating an existing state a heat ray-shielding layer in which flat silver particles and metal oxide particles are mixed and dispersed in a heat ray-shielding material of the present invention.

FIG. 4B is a schematic cross-sectional diagram illustrating an existing state of a flat silver particle-containing layer including flat silver particles and a metal oxide particle-containing layer including metal oxide particles in a heat ray-shielding material of the present invention.

FIG. 4C is a schematic cross-sectional diagram illustrating an existing state of a flat silver particle-containing layer including flat silver particles and metal oxide particle-containing layer including metal oxide particles in a heat ray-shielding material of the present invention, explaining an angle (θ) between a plane of a substrate and a plane of the flat silver particles.

FIG. 5 is an SEM image of a heat ray-shielding material obtained in Example 1, which is observed at a magnification of ×20,000.

FIG. 6 is a graph of a spectrum of a heat ray-shielding material obtained in Example 1.

### DETAILED DESCRIPTION OF THE INVENTION

### Heat Ray-Shielding Material

A heat ray-shielding material of the present invention includes a heat ray-shielding layer including flat silver particles and metal oxide particles, and it further includes other layers such as substrate according to necessity.

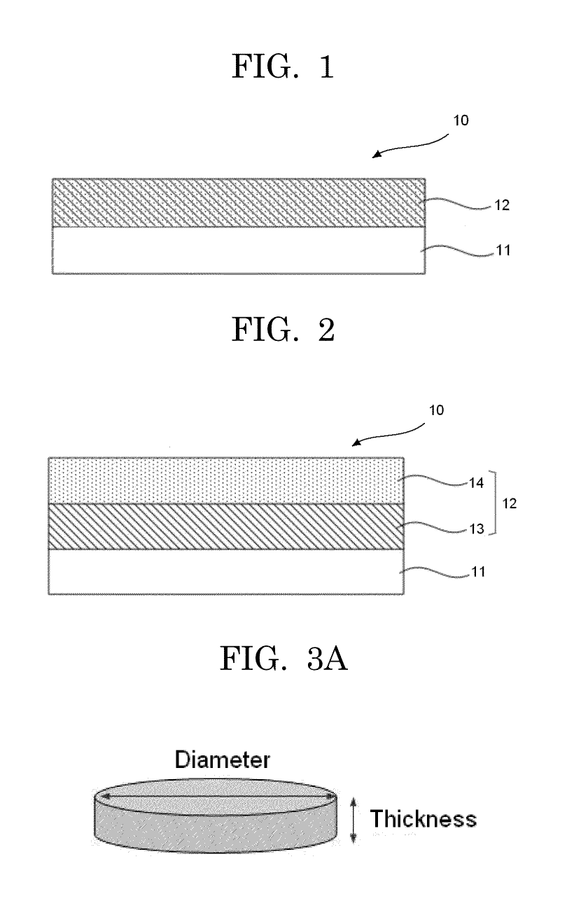

Examples of a layer configuration of the heat ray-shielding material, which is denoted by reference numeral 1 in each figure, include an aspect as illustrated in FIG. 1 that it includes a substrate 11 and a heat ray-shielding layer 12 which is on the substrate and which includes the flat silver particles and the metal oxide particles mixed and dispersed therein, an aspect as illustrated in FIG. 2 that it includes a substrate 11 and a heat ray-shielding layer 12 which is on the substrate and which includes a flat silver particle-containing layer 13 and a metal oxide-containing layer 14 laminated therein.

### <Heat-Ray Shielding Layer>

A shape, a structure, a size and so on of the heat ray-shielding layer are not particularly restricted, and they may be appropriately selected according to purpose. For example, the shape may be a plate; the structure may be a single-layer structure or a laminated structure; and the size may be appropriately selected according to applications.

For the heat ray-shielding layer, there are aspects that, as a first embodiment, the flat silver particles and the metal oxide particles are mixed and dispersed in the binder and that, as a second embodiment, a flat silver particle-containing layer and a metal oxide-containing layer are laminated, for example, and both aspects may be favorably used.

In the first embodiment, the heat ray-shielding layer includes the flat silver particles, the metal oxide particles and the binder, and it further includes other components according to necessity.

The heat ray-shielding layer in the first embodiment may have a single-layer structure that the flat silver particles and the metal oxide particles are mixed and dispersed in the binder, or it may have a multi-layer structure. The single-layer structure is preferable in view of productivity. Also, an application of a mixed solution in which the flat silver particles and the metal oxide particles are mixed and dispersed in the binder is preferable because the heat ray-shielding layer may be formed on a flat or a curved surface of a substrate, and it is more preferable because the heat ray-shielding layer may be formed on a curved surface of the substrate.

In second embodiment, the heat ray-shielding layer includes the flat silver particle-containing layer and a metal oxide particle-containing layer laminated therein. The flat silver particle-containing layer includes the flat silver particles and the binder, and it further includes other components according to necessity. The metal oxide particle-containing layer includes the metal oxide particles and the binder, and it further includes other components according to necessity.

An orientation of the flat silver particles in the flat silver particle-containing layer may be a plane orientation (reflective) or a random orientation (absorptive) as described later.

In any of the first and the second embodiments, it is possible to form the heat ray-shielding layer with a flexible binder, and they are preferable because the heat ray-shielding material thus obtained may be applied to a curved surface.

A thickness of the heat ray-shielding layer is not particularly restricted, may be appropriately selected according to purpose.

Nonetheless, it is preferably 0.01 μm to 10 μm.

### —Flat Silver Particles—

A shape of the flat silver particles are not particularly restricted and may be appropriately selected according to purpose. Nonetheless, the flat silver particles preferably have a substantially triangular plate shape, a substantially hexagonal plate shape, or a substantially disc shape as a rounded shape thereof.

A material of the flat silver particles is not particularly restricted as long as it includes silver, and it may be appropriately selected according to purpose. Nonetheless, it may further include metals such as gold, aluminum, copper, rhodium, nickel and platinum having a high shielding ratio of heat rays (near-infrared light).

A content of the flat silver particles in the heat ray-shielding layer is not particularly restricted, may be appropriately selected according to purpose. Nonetheless, in the both first and second embodiment, it is preferably 0.01 g/m² to 1.00 g/m², and more preferably 0.02 g/m² to 0.20 g/m².

The content of less than 0.01 g/m² may result in insufficient shielding of heat rays. When it exceeds 1.00 g/m², there are cases where visible light transmission degrades. On the other hand, the content of 0.02 g/m² to 0.20 g/m² is advantageous in view of sufficient shielding of heat rays and visible light transmission.

Here, the content of the flat silver particles in the heat ray-shielding layer may be calculated as follows, for example. From observations of an ultrathin-section TEM image and a surface SEM image of the heat ray-shielding layer, a number of the flat silver particles, an average particle diameter and an average thickness in a certain area are measured. Alternatively, regarding the average thickness, the flat silver particles used for the heat ray-shielding layer is coated on a glass plated in a state of a dispersion liquid with no addition of a binder, and the surface is measured by an atomic force microscope. Thereby, the average thickness may be measured with a higher accuracy. The content may be calculated by dividing a mass (g) of the flat silver particles calculated from the number, the average particle diameter and the average thickness of the flat silver particles thus measured as well as from a specific gravity of the flat silver particles by the certain area (m²). Also, a mass (g) of the flat silver particles is obtained by eluting the flat silver particles in a certain area of the heat ray-shielding layer with methanol and measuring by a fluorescent x-ray measurement. The content may also be calculated by dividing the mass by the certain area (m²).

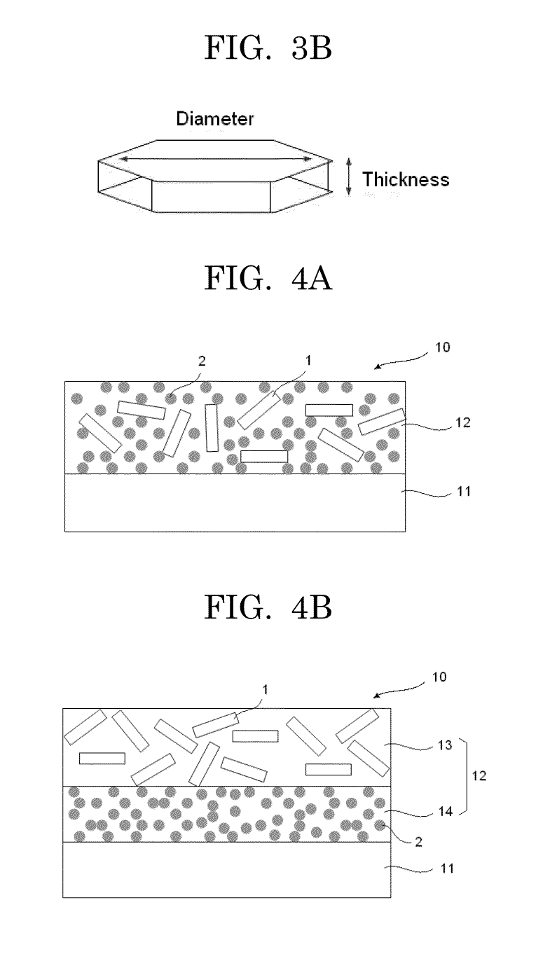

The flat silver particles are not particularly restricted as long as they are particles formed of two main flat surfaces (see FIG. 3A and FIG. 3B), and they may be appropriately selected according to purpose. Examples thereof include a substantially hexagonal shape, a substantially disc shape and a substantially triangular shape. Among these, the substantially hexagonal shape or the substantially disc shape are particularly preferable in view of high visible light transmittance.

The substantially disc shape is not particularly restricted as long as it is a round shape without corners when the flat silver particles are observed from above the main surface by a transmission electron microscope (TEM), and it may be appropriately selected according to purpose.

The substantially hexagonal shape is not particularly restricted as long as it is a substantially hexagonal shape when the flat silver particles are observed from above the main surface by a transmission electron microscope (TEM), and it may be appropriately selected according to purpose. For example, corners of a hexagon may have acute angles or obtuse angles.

A ratio of the substantially hexagonal shape or the substantially disc shape in the flat silver particles is preferably 60% by number or greater, more preferably 65% by number or greater, and particularly preferably 70% by number or greater with respect to the total number of the flat silver particles. When the ratio in the flat silver particles is less than 60% by number, there are cases where visible light transmission decreases.

### [Average Particle Diameter (Average Circle-Equivalent Diameter) and Particle Size Distribution of Average Particle Diameter (Average Circle-Equivalent Diameter)]

An average particle diameter (average circle-equivalent diameter) of the flat silver particles is not particularly restricted, and it may be appropriately selected according to purpose. Nonetheless, it is preferably 40 nm to 400 nm, and more preferably 60 nm to 350 nm. When the average particle diameter (average circle-equivalent diameter) is less than 40 nm, there are cases where a sufficient heat ray-shielding effect is not obtained due to contribution of absorption of the flat silver particles greater than reflection. When it exceeds 400 nm, there are cases where transparency of the substrate is impaired due to increased haze (scattering).

Here, the average particle diameter (average circle-equivalent diameter) means an average value of a main flat plane diameter (maximum length) of arbitrarily selected 200 flat particles obtained by observation of the particle by TEM.

It is possible to incorporate two (2) or more types of flat silver particles having different average particle diameters (average circle-equivalent diameters) in the heat ray-shielding layer. In this case, there may be two (2) or more peaks of the average particle diameters (average circle-equivalent diameters) of the flat silver particles, that is, there may be two (2) average particle diameters (average circle-equivalent diameter).

In the heat ray-shielding material of the present invention, a coefficient of variation in the particle size distribution of the flat silver particles is preferably 30% or less, and more preferably 10% or less. When the coefficient of variation exceeds 30%, there are cases where a region of the shielding wavelength of the heat rays in the heat ray-shielding material becomes broad.

Here, the coefficient of variation in the particle size distribution of the flat silver particles is a value (%) obtained, for example, by plotting a distribution range of the particle diameter of the 200 flat silver particles used for calculation of the average value to find a standard deviation of the particle size distribution and dividing it by an average value (average particle diameter (average circle-equivalent diameter)) of the main-plane diameter (maximum length) obtained as above.

### [Aspect Ratio]

An aspect ratio of the flat silver particles is not particularly restricted, and it may be appropriately selected according to purpose. Nonetheless, it is preferably 2 to 200 and more preferably 5 to 100 due to increased shielding ratio in an infrared light region with a wavelength of 780 nm to 2,000 nm. When the aspect ratio is less than 2, the shielding wavelength becomes less than 780 nm. When it exceeds 200, the shielding wavelength becomes longer than 2,300 nm. In both cases, a sufficient heat ray-shielding effect may not be obtained.

The aspect ratio means a value obtained by dividing the average particle diameter (average circle-equivalent diameter) of the flat silver particles by an average particle thickness of the flat silver particles. The average particle thickness corresponds to a distance between main flat planes of the flat silver particles, as illustrated in FIG. 3A and FIG. 3B, for example, and it may be measured by an atomic force microscope (AFM).

A method for measuring the average particle thickness by the AFM is not particularly restricted, may be appropriately selected according to purpose. For example, a particle dispersion liquid including flat silver particles is dropped on a glass substrate followed by drying, and a thickness of one flat silver particle is measured.

### —Method for Manufacturing Flat Silver Particles—

A method for manufacturing the flat silver particles is not particularly restricted as long as it can synthesize a substantially hexagonal shape or a substantially disc shape, and it may be appropriately selected according to purpose. Examples thereof include liquid phase methods such as chemical reduction method, photochemical reduction method and electrochemical reduction method. Among these, the liquid phase methods such as chemical reduction method and photochemical reduction method are particularly preferable in view of controllability of shape and size. After synthesis of flat silver particles having a hexagonal or triangular shape, an etching treatment with a dissolution species which dissolves silver such as nitric acid, sodium sulfite, halogen ions including Br⁻ and Cl⁻ or an aging treatment by heating is carried out. By rounding the corners of the flat silver particles having a hexagonal or a triangular shape, and flat silver particles having a substantially hexagonal shape or a substantially disc shape may also be obtained.

Here, as the method for manufacturing the flat silver particles other than the above, it is possible to fix seed crystals beforehand on a surface of a transparent substrate such as film and glass for crystal growth of metal particles (e.g. Ag) in a plate shape.

The flat silver particles may be subjected to a further treatment for imparting desired features. The further treatment is not particularly restricted, and it may be appropriately selected according to purpose. Examples thereof include formation of a shell layer having a high refractive index, addition of various additives such as dispersant and antioxidant.

### ——Formation of Shell Layer Having a High Refractive Index——

In order to enhance transparency in a visible light region, the flat silver particles may be coated with a material having a high refractive index with high transparency in a visible light region.

The material having a high refractive index is not particularly restricted, and it may be appropriately selected according to purpose. Examples thereof include TiOₓ, BaTiO₃, ZnO, SnO₂, ZrO₂ and NbOₓ.

The coating method is not particularly restricted, and it may be appropriately selected according to purpose. For example, as reported in Langmuir, 2000, vol. 16, p. 2731-2735, it may be a method of forming a TiOₓ layer on a surface of the flat silver particles by hydrolysis of tetrabuthoxytitanium.

Also, there are cases where it is difficult to form a shell of a metal oxide layer having a high refractive index directly on the flat silver particles. In such cases, flat silver particles are synthesized as above, a shell layer of SiO₂ or a polymer is appropriately formed thereon, and then the metal oxide may further be formed on this shell layer. When TiOₓ is used as a material of the metal oxide layer having a high refractive index, there is a concern that TiOₓ degrades a matrix which disperses the flat silver particles due to its photocatalytic activity. Thus, a SiO₂ layer may be appropriately formed on the flat silver particles after forming a TiOₓ layer according to purpose.

### ——Addition of Various Additives——

The flat silver particles may have an antioxidant such as mercaptotetrazole and ascorbic acid adsorbed thereto in order to prevent oxidation of metals such as silver which constitutes the flat silver particles. Also, for the purpose of preventing oxidation, a sacrificial oxide layer such as Ni may be formed on a surface of the flat silver particles. Also, for the purpose of shielding oxygen, they may be coated with a metal oxide film such as SiO₂.

For the purpose of imparting dispersibility, the flat silver particles may include a dispersant such as low-molecular-weight dispersant and high-molecular-weight dispersant, which include an N element, an S element or a P element, or any combination thereof such as quaternary ammonium salt and amines.

### [Plane Orientation]

In the heat ray-shielding material, main flat planes of the flat silver particles may be randomly oriented with respect to one surface of the heat ray-shielding layer (a substrate surface when the heat ray-shielding material has a substrate), or they may be plane-oriented within a certain range. The former random-orientation type functions mainly as an infrared absorption type, and it is preferable because the heat ray-shielding layer or the flat silver particle-containing layer may be easily formed. The latter plane-orientation type mainly functions as an infrared reflection type, and it is preferable because of superior shielding performance. The both may be favorably used. In the flat silver particle-containing layer, the flat silver particles are preferably plane-oriented within a certain range.

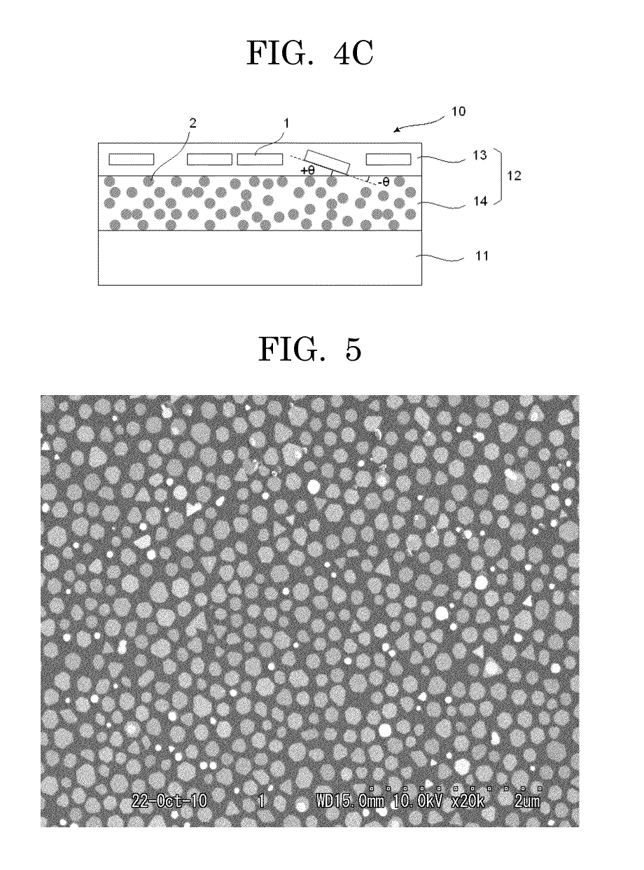

The flat silver particles are not particularly restricted, and they may be appropriately selected according to purpose. Nonetheless, it is preferable that they are unevenly distributed substantially horizontally with respect to one surface of the heat ray-shielding layer (a substrate surface when the heat ray-shielding material includes a substrate) as illustrated in FIG. 4C described hereinafter in view of enhanced heat rays shielding ratio.

The plane orientation is not particularly restricted as long as the main flat planes of the flat silver particles are substantially in parallel within a predetermined range with respect to one surface of the heat ray-shielding layer (a substrate surface when the heat ray-shielding material includes a substrate), and it may be appropriately selected according to purpose. An angle in the plane orientation is preferably 0° to ±30°, and more preferably 0° to ±20°.

Here, FIG. 4A to FIG. 4C are schematic cross-sectional diagrams, each illustrating an existing state of the heat ray-shielding layer including the flat silver particles in the heat ray-shielding material of the present invention. FIG. 4A illustrates the existing state of a heat ray-shielding layer 12 in which flat silver particles 1 and metal oxide particles 2 are mixed and dispersed. FIG. 4B is a diagram illustrating the existing state of flat silver particles in random orientation in a flat silver particle-containing layer 13 including the flat silver particles 1 and a metal oxide particle-containing layer 14 including metal oxide particles 2. FIG. 4C is a diagram illustrating the existing state of flat silver particles in plane orientation in a flat silver particle-containing layer 13 including the flat silver particles 1 and a metal oxide particle-containing layer 14 including metal oxide particles 2, explaining an angle (±θ) between a plane of the heat ray-shielding layer 12 and a plane of the flat silver particles 1 (±θ).

In FIG. 4C, the angle (±θ) between the plane of the heat ray-shielding layer 12 and either the main flat plane of the flat silver particles 1 or an extended line of the main flat plane corresponds to the predetermined range of the plane orientation. That is, the plane orientation is defined as a state where the angle (±θ) illustrated in FIG. 4C is small in observing a cross-section of the heat ray-shielding material. In particular, a state with θ being 0° denotes a state where the plane of the heat ray-shielding layer 12 and the main flat plane of the flat silver particles 1 are in parallel. As illustrated in FIG. 4A and FIG. 4B, when the angle θ of the plane orientation of the main flat planes of the flat silver particles 1 with respect to the surface of the heat ray-shielding layer 12 exceeds ±30°, that is, when the flat silver particles 1 are randomly oriented, the heat ray-shielding material has an increased absorption rate at a predetermined wavelength (for example, from a long wavelength side of a visible light region to near-infrared light region).

### [Evaluation of Plane Orientation]

A method for evaluating whether or not the main flat planes of the flat silver particles are plane-oriented with respect to one surface of the heat ray-shielding layer (a substrate surface when the heat ray-shielding material includes a substrate) is not particularly restricted, and it may be appropriately selected according to purpose. Examples thereof include a method of preparing an appropriate cross-sectional piece and observing and evaluating one surface of the heat ray-shielding layer (a substrate surface when the heat ray-shielding material has a substrate) and the flat silver particles in this piece. Specifically, a cross-sectional sample or a cross-sectional piece of the heat ray-shielding material is prepared using a microtome, a focused ion beam (FIB) and so on, this is observed using various microscopes (e.g. field-emission scanning electron microscope (FE-SEM)), and it is evaluated from an image obtained from the observation.

When the binder coating the flat silver particles in the heat ray-shielding material swells with water, the cross-sectional sample or the cross-sectional piece may be prepared by cutting a sample frozen in liquid nitrogen with a diamond cutter mounted on a microtome. In contrast, when the binder coating the flat silver particles in the heat ray-shielding material does not swell with water, the cross-sectional sample or the cross-sectional piece may be directly prepared.

Observation of the above-prepared cross-sectional sample or the cross-sectional piece is not particularly restricted as long as it can determine whether or not the main flat planes of the flat silver particles is plane-oriented with respect to one surface of the heat ray-shielding layer (a substrate surface when the heat ray-shielding material has a substrate) in the sample, and it may be appropriately selected according to purpose. Examples thereof include observations using a FE-SEM, a TEM and an optical microscope. The cross-sectional sample may be observed under the FE-SEM, and the cross-sectional piece may be observed under the TEM. When the FE-SEM is used for the evaluation, the FE-SEM preferably has a spatial resolution with which the shapes of the flat silver particles and the angle of the plane orientation (±θ in FIG. 4C) can be clearly observed.

A plasmon resonance wavelength λ of the metals constituting the flat silver particles in the heat ray-shielding layer is not particularly restricted, and it may be appropriately selected according to purpose. Nonetheless, it is preferably 400 nm to 2,500 nm in view of imparting a heat ray-shielding performance, and it is more preferably 700 nm to 2,500 nm in view of reducing haze (scattering property) in a visible-light region.

A medium in the heat ray-shielding layer is not particularly restricted, and it may be appropriately selected according to purpose. Examples thereof include: polyvinyl acetal resins such as polyvinyl butyral (PVB) resin; polyvinyl alcohol (PVA) resins; polyvinyl chloride resins; polyester resins such as polyethylene terephthalate (PET); polyurethane resins; ethylene-vinyl acetate copolymer (EVA); polyamide resins; epoxy resins; acrylic resins such as polyacrylate resins and polymethyl methacrylate resins; polycarbonate resin; natural polymers such as gelatin and cellulose; inorganic compounds such as silicon dioxide and aluminum oxide.

The medium preferably has a refractive index (n) of 1.4 to 1.7.

### [Area Ratio of Flat Silver Particles]

An area ratio [(B/A)×100] as a ratio of a total value B of areas of the flat silver particles to an area A of the substrate when the heat ray-shielding material is viewed from above is preferably 15% or greater, and more preferably 20% or greater. When the area ratio is less than 15%, the maximum shielding ratio against heat rays decreases, and there are cases where a sufficient shielding effect is not obtained.

Here, the area ratio may be measured as follows, for example. Specifically, the heat ray-shielding material is observed from above under a SEM observation or an AFM (atomic force microscope) observation. The resultant image is subjected to image processing and provided for the measurement.

### [Average Inter-Particle Distance of Flat Silver Particles]

An average inter-particle distance of the flat silver particles adjacent in a horizontal direction in the heat ray-shielding layer is preferably non-uniform (random). With the average inter-particle distance being not random, i.e. uniform, diffraction occurs, and moiré is observed, which is not preferable as an optical film.

Here, the average inter-particle distance of the flat silver particles in the horizontal direction means an average value of inter-particle distances between two adjacent particles. Also, the average inter-particle distance being random means that “there is no significant local maximum point except the origin in a two-dimensional autocorrelation of brightness values when binarizing a SEM image containing 100 or more flat silver particles”.

### [Layer Configuration of Heat Ray-Shielding Layer]

In the heat ray-shielding material of the present invention, the flat silver particles are disposed, as illustrated in FIG. 4A to FIG. 4C, in a form of the heat ray-shielding layer including the flat silver particles and the metal oxide. As illustrated in FIG. 4A, they may be disposed in a form of the heat ray-shielding layer in which the flat silver particles and the metal oxide particles are mixed and dispersed. Alternatively, as illustrated in FIG. 4B and FIG. 4C, they may be disposed in a form of the heat ray-shielding layer in which the flat silver particle-containing layer including the flat silver particles and the metal oxide particle-containing layer including the metal oxide particles are laminated.

The flat silver particle-containing layer may be composed of a single layer as illustrated in FIG. 4B and FIG. 4C, or it may be composed of a plurality of flat silver particle-containing layers respectively including flat silver particles having different aspect ratios. When it is composed of a plurality of flat silver particle-containing layers, it is possible to impart shielding performance according to a wavelength band at which heat-shielding performance is desired.

### —Metal Oxide Particles—

The material of the metal oxide particles is not particularly restricted, and it may be appropriately selected according to purpose. Examples thereof include tin-doped indium oxide (hereinafter, it is abbreviated as “ITO”), tin-doped antimony oxide (hereinafter, it is abbreviated as “ATO”), zinc oxide, titanium oxide, indium oxide, tin oxide, antimony oxide and glass ceramics. Among these, ITO, ATO and zinc oxide are more preferable since they have superior heat ray-absorption capacity and enable production of the heat ray-shielding material having a wide range of heat ray-absorption capacities as a combination with the flat silver particles. ITO is particularly preferable in view of shielding infrared of 1,200 nm or greater by 90% or greater and having a visible light transmittance of 90% or greater.

Primary particles of the metal oxide particles have a volume-average particle diameter of preferably 0.1 nm or less so as not to reduce the visible light transmittance.

A shape of the metal oxide particles is not particularly restricted, and it may be appropriately selected according to purpose. Examples thereof include a spherical shape, a needle-like shape and a plate shape.

A content of the metal oxide particles in the heat ray-shielding layer is not particularly restricted, and it may be appropriately selected according to purpose. Nonetheless, in the both first and second embodiments, it is preferably 0.1 g/m² to 20 g/m², more preferably 0.5 g/m² to 10 g/m², and further more preferably 1.0 g/m² to 4.0 g/m².

When the content is less than 0.1 g/m², there are cases where an amount of solar irradiation felt on the skin increases. When it exceeds 20 g/m², there are cases where visible light transmittance degrades. On the other hand, the content of 1.0 g/m² to 4.0 g/m² is advantageous since the above two points may be obviated.

Here, the content of the metal oxide particles in the heat ray-shielding layer may be calculated as follows, for example. From observations of an ultrathin-section TEM image and a surface SEM image of the heat ray-shielding layer, a number of the metal oxide particles and an average particle diameter in a certain area are measured. The content may be calculated by dividing a mass (g) calculated based on the number of particles and the average particle diameter as well as a specific gravity of the metal oxide particles by the certain area (m²). Also, a mass (g) of the metal oxide particles is obtained by eluting the metal oxide particles in a certain area of the heat ray-shielding layer with methanol and measuring by a fluorescent x-ray measurement. The content may also be calculated by dividing the mass by the certain area (m²).

### —Binder—

The binder is not particularly restricted, may be appropriately selected according to purpose. Examples thereof include: polyvinyl acetal resins such as polyvinyl butyral (PVB) resin; polyvinyl alcohol (PVA) resins; polyvinyl chloride resins; polyester resins such as polyethylene terephthalate (PET); polyurethane resins; ethylene-vinyl acetate copolymer (EVA); polyamide resins; epoxy resins; acrylic resins such as polyacrylate resins and polymethyl methacrylate resins; polycarbonate resin; natural polymers such as gelatin and cellulose. Among these, the polyvinyl butyral (PVB) resins and the ethylene-vinyl acetate copolymer (EVA) are particularly preferable.

### —Other Components—

The heat ray-shielding layer may include various additives according to necessity. Examples thereof include a solvent, a surfactant, an antioxidant, a sulfide inhibitor, a corrosion inhibitor, an infrared absorber, an ultraviolet absorber, a colorant, a viscosity modifier and a preservative.

### <Substrate>

A shape, a structure, a size and a material of the substrate are not particularly restricted, and they may be appropriately selected according to purpose. For example, the shape may be a plate; the structure may be a single-layer structure or a laminated structure; and the size may be appropriately selected according to the size of the heat ray-shielding material.

The material of the substrate is not particularly restricted, and it may be appropriately selected according to purpose. Examples thereof include polyethylene terephthalate (PET), polyethylene-2,6-naphthalate (PEN), polycarbonate, polyimide (PI), polyethylene, polyvinyl chloride, polyvinylidene chloride, polystyrene and styrene-acrylonitrile copolymer. These may be used alone or in combination of two or more. Among these, mechanical strength, the polyethylene terephthalate (PET) is particularly preferable in view of dimension stability against heat.

A surface of the substrate is preferably subjected to a surface activation treatment in order to improve adhesion with the heat ray-shielding layer thereof. Examples of the surface activation treatment include a glow discharge treatment and a corona discharge treatment.

The substrate may be appropriately synthesized, or commercial products may be used.

A thickness of the substrate is not particularly restricted, and it may be appropriately selected according to purpose. It is preferably 10 μm or greater, and more preferably 50 μm or greater.

### [Method for Manufacturing Heat Ray-Shielding Material]

A method for manufacturing a heat ray-shielding material of the present invention is not particularly restricted, and it may be appropriately selected according to purpose. Examples thereof include: a method of forming by a coating method the heat ray-shielding layer in which the flat silver particles and the metal oxide particles are mixed and dispersed in the binder; a method of forming the heat ray-shielding layer in which the flat silver particle-containing layer and the metal oxide particles layer are laminated on the substrate surface by a coating method.

### —Method for Forming Flat Silver Particle-Containing Layer—

A method for forming the flat silver particle-containing layer is not particularly restricted, and it may be appropriately selected according to purpose. In one possible method, a substrate is coated with a dispersion liquid including the flat silver particles and the binder with a dip coater, a die coater, a slit coater, a bar coater or a gravure coater. In another possible method, the layer is subjected to plane orientation by an LB film method, a self-organizing method or a spray-coating method.

Also, in order to enhance adsorptivity to a substrate surface and plane orientation of the flat silver particles, a method to have the particles plane-oriented using electrostatic interactions may be employed. Specifically, when surfaces of the flat silver particles are negatively charged (for example, the particles are dispersed in a medium which may be negatively charged such as citric acid), the substrate surface is positively charged (for example, the substrate surface is modified with an amino group) to electrostatically enhance plane orientation. Also, when the surfaces of the flat silver particles are hydrophilic, a hydrophilic-hydrophobic sea-island structure is formed on the substrate surface using a block copolymer or a μ-contact stamping method, and plane orientation and the inter-particle distance within the flat silver particles may be controlled using the hydrophilic-hydrophobic interaction.

Here, in order to promote plane orientation, the coated flat silver particles may be passed through pressure rollers such as calender rollers and lamination rollers.

### —Method for Forming Metal Oxide Particle-Containing Layer—

A method for forming the metal oxide particle-containing layer is not particularly restricted, and it may be appropriately selected according to purpose. Examples thereof include methods of coating a substrate with a dispersion liquid including the metal oxide particles and the binder with a dip coater, a die coater, a slit coater, a bar coater or a gravure coater.

The dispersion liquid including the metal oxide particles is not particularly restricted, and it may be appropriately selected according to purpose. Commercial products may be used, and examples of the commercial products include an ITO hard coat coating solution EI-1 (manufactured by Mitsubishi Materials Corporation).

### —Method for Forming Mixed and Dispersed Layer—

A method for forming a heat ray-shielding layer in which the flat silver particles and the metal oxide particles are mixed and dispersed in the binder (mixed and dispersed layer) is not particularly restricted, and it may be appropriately selected according to purpose. Examples thereof include a method of coating a substrate with a dispersion liquid including the flat silver particles, the metal oxide particles and the binder with a dip coater, a die coater, a slit coater, a bar coater or a gravure coater.

A visible light transmission of the heat ray-shielding material of the present invention is preferably 60% or greater, and more preferably 65% or greater. When the heat-shielding material is used as a glass for vehicles or a glass for building material, there are cases where it is difficult to see outside if the visible light transmission thereof is less than 60%.

An average transmittance at 780 nm to 2,000 nm of the heat ray-shielding material of the present invention is preferably 30% or less, and more preferably 20% or less in view of increased efficiency of the heat rays shielding ratio.

Among these, it is particularly preferable that the heat ray-shielding material of the present invention has a visible light transmittance of 65% or greater and an average transmittance at a wavelength of 780 nm to 2,000 nm of 20% or less.

Here, the “visible light transmittance” is a value of each sample measured by a method described in JIS-R3106:1998 “Testing method on transmittance, reflectance and emittance of flat glasses and evaluation of solar heat gain coefficient,” and it is an average value of values corrected by the spectral luminosity of each wavelength, where the values being transmittance at each wavelength measured from 380 nm to 780 nm.

Also, an “average transmittance” in a near infrared region is an average value of transmittance values at respective wavelengths of samples measured at a predetermined near infrared wavelength region (e.g., 780 nm to 2,000 nm).

A haze of the heat ray-shielding material of the present invention is preferably 20% or less, more preferably 10% or less, and particularly preferably 3% or less. When such a material having a haze exceeding 20% is used for a glass for automobiles and a glass for buildings, there are cases it is not preferable in terms of safety since it is difficult to see the outside through the glasses.

### [Mode of Use of Heat Ray-Shielding Material]

A mode of use of the heat ray-shielding material of the present invention is not particularly restricted as long as it is used for selectively reflecting or absorbing heat rays (near-infrared light), and it may be appropriately selected according to purpose. Examples thereof include glasses or films for vehicles, glasses or films for building materials and agricultural films. Among these, the glasses or films for vehicles and the glasses or films for building materials are preferable in view of energy-saving effects.

Here, in the present invention, the heat rays (near-infrared light) means near-infrared light (780 nm to 2,500 nm) included in sunlight by about 50%.

A method for manufacturing the glass is not particularly restricted, and it may be appropriately selected according to purpose. In one possible method, an adhesive layer is further formed on the heat ray-shielding material produced as above. The resultant laminate may be adhered to glasses for vehicles such as automobile or glasses for building materials, or it may be inserted in PVB intermediate films or EVA intermediate films used in a laminated glass. Also, only the heat ray-shielding layer including the flat silver particles and the metal oxide particles is transferred to a PVB intermediate film or an EVA intermediate film with the substrate peeled and removed in use.

### EXAMPLES

Hereinafter, examples of the present invention are explained, but they should not be construed as limiting the present invention.

### Production Example 1

### Synthesis of Flat Silver Particles

### ——Synthesis Steps of Flat Nuclear Particles——

First, 2.5 mL of a 0.5-g/L aqueous solution of polystyrene sulfonate was added to 50 mL of a 2.5-mmol/L aqueous solution of sodium citrate, which was heated to 35° C. To this solution, 3 mL of a 10-mmol/L aqueous solution of sodium borohydride and 50 mL of a 0.5-mmol/L aqueous solution of silver nitrate were added at 20 mL/min with stirring. This solution was stirred for 30 minutes, and a seed solution was prepared.

### ——First Growth Step of Flat Particles——

Next, 87.1 mL of ion-exchanged water was added to 132.7 mL of a 2.5-mmol/L aqueous solution of sodium citrate, which was heated to 35° C. To this solution, 2 mL of a 10-mmol/L aqueous solution of ascorbic acid was added, 42.4 mL of the seed solution was added, and 79.6 mL of a 0.5-mmol/L aqueous solution of silver nitrate was added at 10 mL/min with stirring.

### ——Second Growth Step of Flat Particles——

Next, after the above solution was stirred for 30 minutes, 71.1 mL of a 0.35-mol/L aqueous solution of potassium hydroquinonesulfonate was added, and 200 g of a 7-% by mass aqueous solution of gelatin was added. To this solution, a white precipitate mixture obtained by mixing 107 mL of a 0.25-mol/L aqueous solution of sodium sulfite and 107 mL of a 0.47-mol/L aqueous solution of silver nitrate was added. Immediately after the addition of the white precipitate mixture, 72 mL of a 0.83-mol/L aqueous solution of NaOH was added. At this time, an aqueous solution of NaOH was added while adjusting an addition rate so that the pH did not exceed 10. This was stirred for 300 minutes, and a flat silver particle-containing dispersion liquid a was obtained.

It was confirmed that silver hexagonal flat particles having an average circle-equivalent diameter of 210 nm (hereinafter, they are referred to as Ag hexagonal flat particles) had been formed in this flat silver particle-containing dispersion liquid a. Also, a thickness of the hexagonal flat particles was measured using an atomic force microscope (NANOCUTE II, manufactured by Seiko Instruments Inc.), and it was 18 nm on average. Thus, it was found that flat particles having an aspect ratio of 11.7 were formed.

Next, characteristics of the obtained flat silver particles and the heat ray-shielding material were evaluated as follows. Results are shown in Table 1.

### <<Evaluation of Flat Silver Particles>>

### —Ratio of Flat Particles, Average Particle Diameter (Average Circle-Equivalent Diameter), Coefficient of Variation—

Regarding shape uniformity of the flat Ag particles, shapes of 200 particles arbitrarily extracted from the observed SEM image were subjected to an image analysis to determine particles A having a substantially hexagonal shape or a substantially disc shape and particles B having an irregular shape such as tear shape, and a ratio of particles corresponding to the A (% by number) was obtained.

Also, a particle diameter of 100 particles corresponding to the A was measured using a digital caliper. An average value thereof was regarded as an average particle diameter (average circle-equivalent diameter), and a coefficient of variation (%) as a standard deviation of the particle diameter distribution divided by the average particle diameter (average circle-equivalent diameter) was obtained.

### —Average Particle Thickness—

The obtained flat silver particle-containing dispersion liquid was dropped and dried on a glass substrate, and a thickness of one flat silver particle was measured using an atomic force microscope (AFM) (NANOCUTE II, manufactured by Seiko Instruments Inc.). Here, measurement conditions of using the AFM include: self detection sensor; DFM mode; a measurement range of 5 μm; a scan rate of 180 seconds per 1 frame; and a number of data points of 256×256. —Aspect Ratio—

From the average particle diameter (average circle-equivalent diameter) and the average particle thickness of the obtained flat silver particles, an aspect ratio was calculated by dividing the average particle diameter (average circle-equivalent diameter) by the average particle thickness.

### —Transmission Spectrum—

A transmission spectrum of the obtained flat silver particle-containing dispersion liquid was evaluated by placing the flat silver particle-containing dispersion liquid diluted 40-fold with water in a quartz cell having an optical path length of 1 mm using an ultraviolet/visible/near-infrared spectrophotometer (V-670, manufactured by JASCO Corporation).

TABLE 1

| | | Average | | | Coefficient of | |
|---|---|---|---|---|---|---|
| | | circle-eq. | Average | | variation of | |
| | | diameter | thickness | Aspect | circle-eq. | |
| | | (nm) | (nm) | ratio | diameter (%) | Shape |
| Production | Flat silver | 210 | 18 | 11.7 | 10 | substantially |
| Example 1 | particles a | | | | | hexagonal |
| Production | Flat silver | 310 | 9 | 34.4 | 9 | substantially |
| Example 2 | particles b | | | | | hexagonal |
| Production | Flat silver | 170 | 10 | 17.0 | 8 | substantially |
| Example 3 | particles c | | | | | hexagonal |
| Production | Flat silver | 115 | 10 | 11.5 | 7 | substantially |
| Example 4 | particles d | | | | | hexagonal |
| Production | Flat silver | 130 | 7 | 18.6 | 7 | substantially |
| Example 5 | particles e | | | | | hexagonal |
| Production | Flat silver | 340 | 16 | 21.3 | 11 | substantially |
| Example 6 | particles f | | | | | hexagonal |

| | | | | Ratio of | maximum | |
|---|---|---|---|---|---|---|
| | | | | flat | wavelength of | |
| | | Amount | Concentration | particles | transmission | |
| | | of seed | of NaOH | (% by | spectrum | Productivity |
| | | (mL) | added (mol/L) | number) | (nm) | (mmol/L · h) |
| Production | Flat silver | 42.4 | 0.83 | 89 | 850 | 9.30 |
| Example 1 | particles a | | | | | |
| Production | Flat silver | 42.4 | — | 94 | 1650 | 10.13 |
| Example 2 | particles b | | | | | |
| Production | Flat silver | 127.6 | 0.08 | 93 | 1050 | 9.32 |
| Example 3 | particles c | | | | | |
| Production | Flat silver | 255.2 | 0.08 | 94 | 835 | 9.38 |
| Example 4 | particles d | | | | | |
| Production | Flat silver | 255.2 | — | 93 | 1030 | 10.20 |
| Example 5 | particles e | | | | | |
| Production | Flat silver | 21.2 | 0.17 | 90 | 1250 | 9.53 |
| Example 6 | particles f | | | | | |

### Production Example 2

A flat silver particle-containing dispersion liquid b was prepared in the same manner as Production Example 1 except that 72 mL of ion-exchanged water was added instead of addition of 72 mL of the 0.83-mol/L aqueous solution of NaOH in Production Example 1.

### Production Example 3

A flat silver particle-containing dispersion liquid c was prepared in the same manner as Production Example 1 except that 87.1 mL of the ion-exchanged water was not added, that an addition amount of the seed solution was changed to 127.6 mL and that 72 mL of a 0.08-mol/L aqueous solution of NaOH was added instead of addition of 72 mL of the 0.83-mol/L aqueous solution of NaOH in Production Example 1.

### Production Example 4

A flat silver particle-containing dispersion liquid d was prepared in the same manner as Production Example 3 except that 132.7 mL of the 2.5-mmol/L aqueous solution of sodium citrate was not added and that the addition amount of the seed solution was changed to 255.2 mL in Production Example 3.

### Production Example 5

A flat silver particle-containing dispersion liquid e was prepared in the same manner as Production Example 4 except that 72 mL of ion-exchanged water was added instead of addition of 72 mL of the 0.08-mol/L aqueous solution of NaOH in Production Example 4.

### Production Example 6

A flat silver particle-containing dispersion liquid f was prepared in the same manner as Production Example 1 except that an addition amount of the seed solution was changed from 42.4 mL to 21.2 mL and that 21.2 mL of ion-exchanged water was added in Production Example 1.

### Example 1

### Preparation of Plane Oriented Layer of Flat Silver Particles

To 16 mL of the flat silver particle-containing dispersion liquid e of Production Example 5, 0.75 mL of 1-N NaOH was added, and 24 mL of ion-exchanged water was added, which was subjected to centrifugation in a centrifuge (H-200N, ANGLE ROTOR BN, manufactured by Kokusan Co., Ltd.) at 5,000 rpm for 5 minutes, and Ag hexagonal flat particles were precipitated. A supernatant after centrifugation was discarded, 5 mL of water was added, and the precipitated Ag hexagonal flat particles were re-dispersed. To this dispersion liquid, 1.6 mL of a 2-% by mass water-methanol solution (water:methanol=1:1 (mass ratio)) of a compound represented by Structural Formula (I) below was added, and a coating solution was prepared. This coating solution was applied on a PET film having a thickness of 50 μm (A4300, manufactured by Toyobo Co., Ltd.) using a wire coating bar No. 14 (manufactured by RD Specialties, Inc., Webster N.Y.) followed by drying, and a film having an Ag hexagonal flat particles fixed on a surface thereof was obtained. Thereby, a plane oriented layer of flat silver particles was prepared.

A carbon thin film was deposited on the obtained PET film such that it had a thickness of 20 nm, and then it was subjected to an SEM observation (FE-SEM, S-4300, manufactured by Hitachi, Ltd., at 2 kV and at a magnification of ×20,000). The result is shown in FIG. 5. It was found that the Ag hexagonal flat particles were fixed without aggregation on the PET film and that an area ratio of the Ag hexagonal flat particles on the substrate surface measured as follows was 45%. Also, it was found that a content of the flat silver particles in the plane oriented layer of flat silver particles measured as follows was 0.04 g/m².

### —Preparation of Heat-Shielding Film—

Next, an ITO hard coat coating solution (EI-1, manufactured by Mitsubishi Materials Corporation) was applied on a backside surface on the PET film on which the flat Ag particles had been coated using a wire coating bar No. 10 (manufactured by RD Specialties, Inc., Webster N.Y.) such that it has a layer thickness after drying of 1.5 μm, and a heat-shielding film 1 was obtained. Here, it was found that a content of the ITO particles in the metal oxide particle-containing layer as measured below was 3.0 g/m².

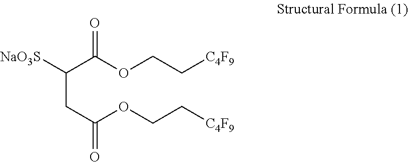

### Preparation of Heat-Shielding Film—

The heat-shielding film 1 was sandwiched between polyvinyl butyral films for automobiles having a thickness of 0.38 mm (manufactured by Solutia Co., Ltd.), and the laminate was further sandwiched by glass plates having a thickness of 2 mm (each plate has a size in a plane direction of a 50-mm square). The laminate under such a condition was passed through a roll laminator having metal rollers heated to 60° C., and it was temporarily pressure bonded. The temporarily pressure bonded sample was placed in an autoclave and was permanently pressure bonded under conditions of 130° C., 30 minutes and 13 atm, and a heat-shielding glass 1 of Example 1 was obtained.

### <<Evaluation of Heat-Shielding Film>>

Characteristics of the obtained heat-shielding film were evaluated as follows. Results of the evaluations are shown in Table 2.

### —Area Ratio—

An SEM image obtained by observation of the obtained heat-shielding film by a scanning electron microscope (SEM) was binarized, an area ratio [B/A)×100] was obtained as a ratio of a sum B of an area of the flat silver particles to an area A of the substrate when viewed from above the heat-shielding film heat-shielding film (a total projected area A of the heat-shielding film when viewed from a direction perpendicular to the heat-shielding film).

### —Radio-Wave Transmittance—

The heat-shielding film was measured using a KEC method at Tokyo Metropolitan Industrial Technology Research Institute. It was determined to have radio-wave transmittance with a shielding effect of 5 dB or less.

### <<Evaluation of Heat-Shielding Glass>>

Next, characteristics of the obtained heat-shielding glass were evaluated as follows. Results of the evaluations are shown in Table 2.

### —Visible-Light Transmission Spectrum—

A transmission spectrum of the obtained heat-shielding film was evaluated according to the JIS, an evaluation standard of automotive glass.

The transmission spectrum was evaluated using an ultraviolet/visible/near-infrared spectrophotometer (V-670, manufactured by JASCO Corporation). An incident light was passed through a 45° polarizer, and it was regarded as a non-polarized light.

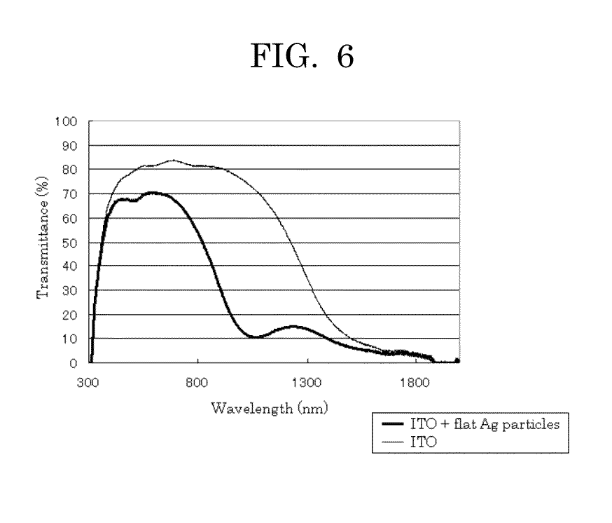

FIG. 6 is a graph illustrating a spectrum of the shielding film 1 obtained in Example 1.

### —Visible Light Transmission/Initial Near-Infrared Transmittance—

A visible light transmission is a value of each sample measured according to a method described in JIS-R3106: 1998 “Testing method on transmittance, reflectance and emittance of flat glasses and evaluation of solar heat gain coefficient”, and it is an average value of values corrected by the spectral luminosity of each wavelength, where the values being transmittance at each wavelength measured from 380 nm to 780 nm. An initial near-infrared transmittance is an average value of transmittance of each sample at each wavelength measured from 780 nm to 2,000 nm.

### —Lightfastness—

A lightfastness value of shielding performance of a sample was defined as a value expressed in percentage of a proportion of an initial near-infrared transmittance against a near-infrared transmittance after a certain lightfastness test imposed on the sample. A line considered as favorable was 90% or greater. The certain lightfastness test is an exposure test at 180 W/m, 63° C. and 30% RH for 1,000 hours in SUNSHINE WEATHER METER (manufactured by Suga Test Instruments Co., Ltd., xenon lamp irradiation).

### —Measurement of Haze—

Using a haze meter (NDH-5000, manufactured by Nippon Denshoku Industries Co., Ltd.), a haze (%) of the heat-shielding film obtained as above was measured. As a result of the evaluation of the heat-shielding film, the haze thereof was 0.8%.

### —Measurement of Contents of Flat Silver Particles and ITO Particles—

First, the flat silver particles and ITO particles in a specific area of the heat ray-shielding layer (coating film) were eluted with methanol. Then, a mass of the flat silver particles and the ITO particles were respectively measured by a fluorescent x-ray measurement. Finally, the mass was divided by the respective specific area. Thereby, a content of the flat silver particles in the heat ray-shielding layer and a content of the ITO particles in the heat ray-shielding layer were calculated.

### Example 2

### Preparation of Heat-Shielding Film and Heat-Shielding Glass

A heat-shielding film 2 and a heat-shielding glass 2 of Example 2 were prepared in the same manner as Example 1 except that the flat silver particle-containing dispersion liquid b of Production Example 2 was used instead of using the flat silver particle-containing dispersion liquid e of Production Example 5 in Example 1.

### Example 3

### Preparation of Random Oriented Layer of Flat Silver Particles

First, 0.75 mL of 1-N NaOH was added to 16 mL of flat silver particle-containing dispersion liquid c, d and f of Production Examples 3, 4 and 6, respectively, and with an addition of 24 mL of ion-exchanged water, they were subjected to centrifugation in a centrifuge (H-200N, ANGLE ROTOR BN, manufactured by Kokusan Co., Ltd.) at 5,000 rpm for 5 minutes to precipitate Ag hexagonal flat particles. After the centrifugation, supernatant was discarded, 5 mL of water was added, and the precipitated Ag hexagonal flat particles were re-dispersed. To each of these three (3) dispersion liquids, 1.6 mL of an aqueous solution of 10-% by mass gelatin was added followed by mixing, and coating solutions were prepared. Each of these coating solutions was applied on a PET film using a wire coating bar No. 14 (manufactured by RD Specialties, Inc., Webster N.Y.) followed by drying. Thereby, PET films having Ag hexagonal flat particles randomly oriented near a surface thereof were obtained. By the above, random oriented layers of flat silver particles were prepared.

### —Preparation of Heat-Shielding Film and Heat-Shielding Glass—

A heat-shielding film 3 and a heat-shielding glass 3 of Example 3 were obtained in the same manner as Example 1 except that a random oriented layer of flat silver particles was used in place of the plane oriented layer of flat silver particles in Example 1.

### Example 4

### Preparation of Heat-Shielding Film and Heat-Shielding Glass

A heat-shielding film 4 and a heat-shielding glass 4 of Example 4 were prepared in the same manner as Example 3 except that flat silver particle-containing dispersion liquids a and e of Production Examples 1 and 5 were used in place of flat silver particle-containing dispersion liquids c, d and f of Production Examples 3, 4 and 6 in Example 3.

### Example 5

### Mixing and Dispersing

### —Preparation Of Heat-Shielding Film—

A random oriented layer of flat silver particles in Example 3 was prepared using a B4-sized large glass plate in place of the PET film, and the random oriented layer of flat silver particles was scraped off using a single-edged razor blade. This was repeated for 10 sheets, and flat silver particle-containing powder was collected. Also, an ITO hard coat coating solution (EI-1, manufactured by Mitsubishi Materials Corporation) was coated on a separate B4-sized large glass plate using a wire coating bar No. (manufactured by RD Specialties, Inc., Webster N.Y.) such that it had a layer thickness after drying of 1.5 μm, and the obtained ITO particles-containing layer was scraped off from the glass surface using a single-edged razor blade. This was repeated for 10 sheets, and ITO particle-containing powder was collected.

The flat silver particle-containing powder and the ITO particle-containing powder were heated to 150° C. and mixed, and the mixture was formed into pellets. Then, 90 parts by mass of ethanol was added to 10 parts by mass of these pellets for dissolution, and a coating solution was obtained. This coating solution was applied on a PET film using a wire coating bar No. 10 (manufactured by RD Specialties, Inc., Webster N.Y.) such that it had a layer thickness after drying of 1.5 μm, and a heat-shielding film 5 of Example 5 was obtained.

### —Preparation of Heat-Shielding Film—

A heat-shielding glass 5 of Example 5 was obtained in the same manner as Example 1 except that the heat-shielding film 5 was used in place of the heat-shielding film 1 in Example 1.

### Comparative Example 1

### Diimmonium-Based Organic Pigment-Containing Layer and ITO-containing Layer

### —Preparation of Heat-Shielding Film—

First, a PET film including a diimmonium-based organic pigment as an organic heat ray-shielding material was obtained according to the following procedure.

A coating solution was prepared by mixing and stirring 20 parts by mass of methyl ethyl ketone, 20 parts by mass of toluene, 50 parts by mass of an acrylic resin (LP-45M, manufactured by Soken Chemical & Engineering Co., Ltd.), 5 parts by mass of diimmonium-based organic pigment (N,N,N,N-tetrakis(p-dibutylaminophenyl)-1,4-benzeneiminium ditetraoxychlorate; IRG023, manufactured by Nippon Kayaku Co., Ltd.), and 5 parts by mass of an ultraviolet ray absorber 2-(2′-hydroxy-5′-t-octylphenyl)benzotriazole (KEMISORB 79, manufactured by Chemipro Kasei Kaisha, Ltd.). This coating solution was applied on a PET film (A4300, manufactured by Toyobo Co., Ltd.) having a thickness of 50 μm using a wire coating bar No. 10 (manufactured by RD Specialties, Inc., Webster N.Y.) such that the layer had a thickness after drying of 2.5 μm, followed by drying at 100° C. for 3 minutes, and a PET film including a diimmonium-based organic pigment-containing layer was obtained.

Next, an ITO hard coat coating solution (EI-1, manufactured by Mitsubishi Materials Corporation) was applied on a back surface of the PET film opposite to the diimmonium-based material coated surface such that it had a layer thickness after drying of 1.5 μm using a wire coating bar No. 10 (manufactured by RD Specialties, Inc., Webster N.Y.), and a heat-shielding film A of Comparative Example 1 was obtained.

Here, the heat-shielding film A of Comparative Example 1 corresponds to a heat rays shielding film disclosed in JP-A No. 2008-20525.

### —Preparation of Heat-Shielding Film—

A heat-shielding glass A of Comparative Example 1 was obtained in the same manner as Example 1 except that the heat-shielding film A was used in place of the heat-shielding film 1 in Example 1.

### Comparative Example 2

### Dispersion Layer of ITO Alone

### —Preparation of Heat-Shielding Film—

An ITO hard coat coating solution (EI-1, manufactured by Mitsubishi Materials Corporation) was applied On a surface of a PET film having a thickness of 50 μm (A4300, manufactured by Toyobo Co., Ltd.) using a wire coating bar No. 10 (manufactured by RD Specialties, Inc., Webster N.Y.) such that it had a layer thickness after drying of 1.5 μm, and a heat-shielding film B of Comparative Example 2 was obtained.

### —Preparation of Heat-Shielding Film—

A heat-shielding glass B of Comparative Example 2 was obtained in the same manner as Example 1 except that the heat-shielding film B was used in place of the heat-shielding film 1 in Example 1.

### Comparative Example 3

### Dispersion Layer of Flat Silver Particles Alone

### —Preparation of Heat-Shielding Film and Heat-Shielding Glass—

A heat-shielding film C and a heat-shielding glass C of Comparative Example 3 were prepared in the same manner as Example 1 except that the ITO hard coat coating solution was not applied in Example 1.

Next, characteristics of the heat-shielding films 2 to 5 and A to C and the heat-shielding glasses 2 to 5 and A to C of Examples 2 to 5 and Comparative Examples 1 to 3 were evaluated in the same manner as Example 1. Here, the measurement of the area ratio was not carried out in Examples 3 to 5 and Comparative Examples 1 and 2 since it was not possible. Results are shown in Table 2.

As it may be seen from Table 2, the heat-shielding films and heat-shielding glasses manufactured by the manufacturing method of the present invention has a high visible-light transmittance of 65% or greater while maintaining radio-wave transmittance, having a high lightfastness, capable of shielding near-infrared light in wide band of 780 nm to 2,000 nm, and having an average transmittance of the near-infrared light of 20% or less.

TABLE 2

| | Flat silver | Content of | | | |
|---|---|---|---|---|---|
| | particle- | flat silver | Content of | | Visible light |
| | dispersion | particles | ITO particles | Area ratio | transmission |
| | liquid used | (g/m²) | (g/m²) | (%) | (%) |
| Example 1 | e | 0.04 | 3.0 | 45 | 70 |
| Example 2 | b | 0.06 | 3.0 | 48 | 76 |
| Example 3 | c, d, f | 0.05 | 3.0 | — | 65 |
| Example 4 | a, e | 0.06 | 3.0 | — | 67 |
| Example 5 | c, d, f | 0.07 | 3.2 | — | 65 |
| Comparative | — | 0 | 3.0 | — | 63 |
| Example 1 | | | | | |
| Comparative | — | 0 | 3.0 | — | 82 |
| Example 2 | | | | | |
| Comparative | e | 0.04 | 0 | 45 | 75 |
| Example 3 | | | | | |

| | Near-infrared | | Heat- | Maximum | | |
|---|---|---|---|---|---|---|
| | transmittance (%) | | shielding | wavelength | | |
| | | After | performance | of shielding | Radio-wave | |
| | | lightfastness | lightfastness | spectrum | transmittance | Haze |
| | Initial | test | (%) | (nm) | (dB) | (%) |
| Example 1 | 13.4 | 13.0 | 97 | 1,030 | 0.5 | 0.8 |
| Example 2 | 20.0 | 20.0 | 100 | 1,650 | 0.5 | 1.6 |
| Example 3 | 8.6 | 8.2 | 95 | 1,050 | 0.8 | 1.4 |
| Example 4 | 9.4 | 8.9 | 95 | 950 | 0.7 | 1.5 |
| Example 5 | 8.8 | 8.2 | 93 | 1,050 | 0.8 | 1.7 |
| Comparative | 11.8 | 9.0 | 76 | 1,050 | 0.6 | 0.9 |
| Example 1 | | | | | | |
| Comparative | 35.0 | 35.0 | 100 | 2,000 | 0.5 | 0.5 |
| Example 2 | | | | | | |
| Comparative | 38.4 | 37.5 | 97 | 1,030 | 0.5 | 0.7 |
| Example 3 | | | | | | |

### INDUSTRIAL APPLICABILITY

The heat ray-shielding material of the present invention has superior visible-light transmittance, radio-wave transmittance and lightfastness, is capable of shielding near-infrared light in wide band, and has a high shielding ratio of near-infrared light. Accordingly, it may be favorably used for various members required to prevent transmission of heat rays including glass for vehicles such as cars and buses and glass for building materials.

What is claimed is:

1. A heat ray-shielding material, comprising:
a heat ray-shielding layer which comprises flat silver particles and metal oxide particles.

2. The heat ray-shielding material according to claim 1,
wherein the metal oxide particles are tin-doped indium oxide particles.

3. The heat ray-shielding material according to claim 1,
wherein the flat silver particles comprise flat silver particles having a substantially hexagonal shape or a substantially disc shape by 60% by number or greater.

4. The heat ray-shielding material according to claim 1,
wherein the flat silver particles have a coefficient of variation in a particle size distribution of 30% or less.

5. The heat ray-shielding material according to claim 1,
wherein the flat silver particles have an average particle diameter of 40 nm to 400 nm, and the flat silver particles have an aspect ratio (average particle diameter/average particle thickness) of 5 to 100.

6. The heat ray-shielding material according to claim 1,
wherein a content of the flat silver particles in the heat ray-shielding layer is 0.02 g/m² to 0.20 g/m².

7. The heat ray-shielding material according to claim 1,
wherein a content of the metal oxide particles in the heat ray-shielding layer is 1.0 g/m² to 4.0 g/m².

8. The heat ray-shielding material according to claim 1,
wherein the heat ray-shielding material has a visible light transmittance of 65% or greater and an average transmittance at a wavelength of 780 nm to 2,000 nm of 20% or less.

9. The heat ray-shielding material according to claim 1,
wherein the heat ray-shielding layer comprises the flat silver particles and the metal oxide particles mixed and dispersed in a binder.

10. The heat ray-shielding material according to claim 1,
wherein the heat ray-shielding layer comprises a flat silver particle-containing layer comprising the flat silver particles and a metal oxide particle-containing layer comprising the metal oxide particles laminated therein.
